(19) United States
(12) Patent Application Publication
(10) Pub. No.: US 2016/0309509 A1
(43) Pub. Date: Oct. 20, 2016

(54) METHODS FOR INDICATING AND DETERMINING TO USE SPECTRUM, AND APPARATUS

(71) Applicant: Huawei Technologies Co., Ltd., Shenzhen (CN)

(72) Inventors: Zhiyu Yan, Beijing (CN); Sha Ma, Beijing (CN)

(21) Appl. No.: 15/192,616

(22) Filed: Jun. 24, 2016

Related U.S. Application Data
(63) Continuation of application No. PCT/CN2013/090472, filed on Dec. 25, 2013.

(51) Int. Cl. H04W 74/00; H04W 48/12; H04W 16/14

(52) U.S. Cl. CPC H04W 74/006; H04W 16/14; H04W 48/12

(57) ABSTRACT

This application provides methods for indicating and determining to use a spectrum, and an apparatus. The method includes: sending, in a Pcell, a first wireless network identifier to UE, where a carrier used in the Pcell is a carrier in a non-shared spectrum; and sending, in a Scell, a second wireless network identifier that is the same as the first wireless network identifier to the UE, where a carrier used in the Scell is a carrier in a shared spectrum, and the first wireless network identifier/the second wireless network identifier uniquely identifies one wireless network operator. This application avoids a problem of chaotic user data scheduling performed by a network that is caused by an invalid or erroneous scheduling result that is produced because operators plan cells with a same Cell-ID in a shared spectrum in a same geographical area.

### CROSS-REFERENCE TO RELATED APPLICATIONS

This application is a continuation of International Application No. PCT/CN2013/090472, filed on Dec. 25, 2013, which is hereby incorporated by reference in its entirety.

### TECHNICAL FIELD

The present application relates to the field of wireless communications technologies, and in particular, to methods for indicating and determining to use a spectrum, and an apparatus.

### BACKGROUND

In a current wireless network system, in order to avoid or reduce interference between different wireless technologies, a fixed spectrum allocation policy is widely used. That is, a national government agency performs spectrum allocation, and separately allocates some spectrums to a specified institution to provide a particular service, where a spectrum specified for allocation is referred to as a licensed spectrum, and a spectrum not specified for allocation is referred to as an unlicensed spectrum. According to the latest FCC international spectrum white paper issued, there may be more unlicensed spectrum resources than licensed spectrum resources. Therefore, when LTE (Long Term Evolution) devices are applied in unlicensed spectrums, unlicensed spectrum resources can be effectively used, and further, more effective wireless access can be provided, and increasing mobile bandwidth service demands can be satisfied.

Wireless communications systems and operators have unrestricted access to unlicensed spectrums. That is, a case in which multiple operators of multiple communications systems or different operators of a same communications system desire to occupy a same spectrum exists. For example, multiple operators deploy LTE communication nodes in a geographical area, and each operator does not consider a network planning status of another operator or another system when using same spectrums to send data; therefore, different operators may use a same cell identifier Cell-ID in these shared spectrums in the same geographical area.

Signals sent on some physical layer channels in an LTE system include predefined sequence signals, for example, a synchronization signal and a cell-specific reference signal (CRS, also referred to as a common reference signal), and these sequence signals are related to only corresponding Cell-IDs. For a synchronization signal, a Zadoff-Chu sequence is used for a primary synchronization signal, and an m sequence is used for a secondary synchronization signal. For a particular Cell-ID, a particular primary synchronization signal sequence and secondary synchronization signal sequence are correspondingly generated according to a manner of generating a primary synchronization signal and a secondary synchronization signal. Similarly, a generation manner and a resource mapping manner of a CRS sequence in an LTE system are also related only to a Cell-ID of a cell. For a particular Cell-ID, a particular CRS signal sequence is correspondingly generated, and the signal is mapped to a same resource for sending.

As shown in FIG. 1, some geographical areas of a Cell 2 planned by an operator 1 in an unlicensed spectrum are the same as those of a Cell 2 planned by an operator 2 in the unlicensed spectrum. Because each operator does not consider a network planning status of another operator or another system when using the same spectrum to send data, the operator 1 and the operator 2 may use a same Cell-ID in the Cell 2 planned by the operator 1 in the unlicensed spectrum and the Cell 2 planned by the operator 2 in the unlicensed spectrum. When a user's user equipment CUE) 1 of the operator 1 receives and demodulates a physical signal sequence of the operator 1 in the Cell 2, the UE 1 may receive a physical signal sequence of the operator 2 in the Cell 2. From the perspective of a received physical signal, a user cannot distinguish whether the received signal is from the Cell 2 of the operator 1 in the unlicensed spectrum or the Cell 2 of the operator 2 in the unlicensed spectrum. For example, in a process in which the UE 1 measures a CRS signal, an actual situation is that when a signal sent in the Cell 2 of the operator 1 arrives at the UE, the signal is severely interfered by a signal sent in the Cell 2 of the operator 2. However, from the perspective of a measured CRS signal, because CRS signals sent by the two operators are exactly the same, the CRS signal cannot reflect an interference status, and in addition, the UE can receive both the CRSs, so that quality of the measured CRS signal is very high. After a measurement result is reported to the Cell 2 of the operator 1, the operator 1 performs corresponding configuration, data scheduling, and the like on the UE according to the measurement result. Because configuration and data scheduling results are actually greatly inconsistent with communication quality of the UE in the Cell 2 of the operator 1, invalid or erroneous scheduling results are produced, which cause a problem of subsequent chaotic user data scheduling performed by a network.

In a current wireless network system, all systems deployed by different LTE system operators are in separate licensed spectrums, and a problem that different operators plan cells with a same Cell-ID in shared spectrums in a same geographical area does not exist.

As can be seen, when different operators use a shared spectrum to deploy LTE system networks, the different operators may plan cells with a same Cell-ID in a shared spectrum in a same geographical area because an operator does not consider a network planning status of another operator when using the shared spectrum. This problem remains unresolved in the prior art.

### SUMMARY

Embodiments of the present application provide methods for indicating and determining to use a spectrum, and an apparatus, so as to avoid a problem of chaotic user data scheduling performed by a network that is caused by an invalid or erroneous scheduling result that is produced because different operators plan cells with a same Cell-ID in a shared spectrum in a same geographical area.

According to a first aspect, a method for indicating, by a network side apparatus, to use a spectrum is provided, including:

sending, in a primary cell (Pcell), a first wireless network identifier to UE, where a carrier used in the Pcell is a carrier in a non-shared spectrum; and

sending, in a secondary cell (Scell), a second wireless network identifier that is the same as the first wireless network identifier to the UE, so that the UE determines whether the UE can communicate with a network side apparatus in the Scell, where a carrier used in the Scell is a carrier in a shared spectrum, and the first wireless network identifier/the second wireless network identifier uniquely identifies one wireless network operator.

With reference to the first aspect, in a first possible implementation manner, after the sending, in the Pcell, the first wireless network identifier to UE and sending, in the Scell, the second wireless network identifier to the UE, the method further includes:

when determining that feedback information that is returned by the UE and that includes a signal measurement result for the Scell is not received, or when determining that feedback information that is returned by the UE and that indicates that a signal measurement result for the Scell is invalid is received, or when determining that feedback information that is returned by the UE and that instructs to change a cell identifier of the Scell is received, skipping performing resource configuration and data scheduling for the UE or changing the cell identifier of the Scell; and

when the feedback information that is returned by the UE and that includes the signal measurement result for the Scell is received, performing resource configuration and data scheduling for the UE according to the signal measurement result for the Scell.

With reference to the first aspect, in a second possible implementation manner, wherein the sending, in the Scell, the second wireless network identifier to the UE specifically comprises: sending, in the Scell, the second wireless network identifier to the UE by using a first downlink shared channel, where a transmission channel of scheduling information that corresponds to the first downlink shared channel is in first common search space of a control channel, and the first common search space of a control channel is common search space of the Pcell or common search space of the Scell; or

sending, in the Scell, the second wireless network identifier to the UE by using a second downlink shared channel, where a resource that corresponds to the second downlink shared channel is a preset resource that corresponds to a cell identifier of the Scell; or

sending, in the Scell to the UE by using a third downlink shared channel, the second wireless network identifier and a preset sequence that is used to identify the second wireless network identifier.

According to a second aspect, a method for determining, by user equipment (UE), to use a spectrum is provided, including:

receiving a first wireless network identifier that is sent in a primary cell (Pcell) by a network side apparatus, and searching for a second wireless network identifier that is sent in a secondary cell (Scell) by the network side apparatus, where a carrier used in the Pcell is a carrier in a non-shared spectrum, and a carrier used in the Scell is a carrier in a shared spectrum;

when the second wireless network identifier that is sent in the Scell by the network side apparatus is received, and determining that the second wireless network identifier is consistent with the first wireless network identifier that is sent in the Pcell by the network side apparatus, determining that communication with the network side apparatus can be performed in the Scell; and

when the second wireless network identifier that is sent in the Scell by the network side apparatus is not received, or when the second wireless network identifier that is sent in the Scell by the network side apparatus is received, and determining that the second wireless network identifier is inconsistent with the first wireless network identifier that is sent in the Pcell by the network side apparatus, determining that communication with the network side apparatus cannot be performed in the Scell.

With reference to the second aspect, in a first possible implementation manner, when determining that communication with the network side apparatus can be performed in the Scell, the method further includes: feeding back a signal measurement result for the Scell to the network side apparatus; or

when determining that communication with the network side apparatus cannot be performed in the Scell, the method further includes:

skipping feeding back a signal measurement result for the Scell to the network side apparatus, or feeding back, to the network side apparatus, feedback information that indicates that a signal measurement result for the Scell is invalid, or feeding back, to the network side apparatus, feedback information that instructs to change a cell identifier of the Scell.

With reference to the second aspect, in a second possible implementation manner, searching, by using a first downlink shared channel, for the second wireless network identifier that is sent in the Scell by the network side apparatus, where a transmission channel of scheduling information that corresponds to the first downlink shared channel is in first common search space of a control channel, and the first common search space of a control channel is common search space of the Pcell or common search space of the Scell; or

searching, by using a second downlink shared channel, for the second wireless network identifier that is sent in the Scell by the network side apparatus, where a resource that corresponds to the second downlink shared channel is a preset resource that corresponds to a cell identifier of the Scell; or

searching, on a third downlink shared channel according to a stored preset sequence, for the second wireless network identifier that is sent in the Scell by the network side apparatus.

According to a third aspect, a method for determining a cell identifier in a spectrum by a network side apparatus is provided, including:

when determining to perform time alignment, aligning an alignment system time with a time location in a time segment according to stored M time segments, and establishing, according to a circular order of the stored M time segments, relationships in which the M time segments correspond to system time in the preset circular order, where M is an integer greater than 1; and

when determining that communication with user equipment (UE) needs to be performed on a carrier in a shared spectrum by using a Cell-ID, determining, according to the established relationships in which the M time segments correspond to the system time in the preset circular order, a time segment that corresponds to current system time, determining, according to correspondences between the stored M time segments and Cell-IDs, a Cell-ID that corresponds to the time segment, and performing communication with the UE on the carrier in the shared spectrum by using the determined Cell-ID, where for different wireless network operators, Cell-IDs that correspond to a same time segment are different.

With reference to the third aspect, in a first possible implementation manner, the method further includes:

delivering the stored M time segments, the circular order of the M time segments, and the correspondences between the M time segments and the Cell-IDs to the UE.

With reference to the third aspect, in a second possible implementation manner, the method further includes:

when a timing moment arrives, determining a time segment of the current system time, and a time location t, of the current system time, in the time segment; and broadcasting, to the UE, the determined time location t and a Cell-ID that corresponds to the time segment of the current system time; or

when a time request of the UE is received, determining a time segment of the current system time, and a time location t, of the current system time, in the time segment; and sending, to the UE, the determined time location t and a Cell-ID that corresponds to the time segment of the current system time; or

when determining that a connection with the UE needs to be established, determining a time segment T of the current system time, and a time location t, of the current system time, in the time segment; and sending, to the UE, the determined time location t and a Cell-ID that corresponds to the time segment of the current system time.

With reference to the third aspect, in a third possible implementation manner, when communication with the UE is performed on the carrier in the shared spectrum by using the Cell-ID that corresponds to the time segment, the method further includes:

sending a time location t, of the current system time, in the time segment to the UE.

According to a fourth aspect, a method for determining, by user equipment (UE), a cell identifier Cell-ID in a spectrum is provided, including:

when determining to perform time alignment, aligning an alignment system time with a time location in a time segment in stored M time segments, and establishing, according to a circular order of the stored M time segments, relationships in which the M time segments correspond to system time in the preset circular order, where M is an integer greater than 1; and

when determining that communication with a network side apparatus needs to be performed on a carrier in a shared spectrum by using a Cell-ID, determining, according to the established relationships in which the M time segments correspond to the system time in the preset circular order, a time segment that corresponds to current system time, determining, according to correspondences between the stored M time segments and Cell-IDs, a Cell-ID that corresponds to the time segment, and performing communication with the network side apparatus on the carrier in the shared spectrum by using the determined Cell-ID.

With reference to the fourth aspect, in a first possible implementation manner, the determining to perform time alignment specifically includes:

when receiving a Cell-ID and a time location t that are sent by the network side apparatus when the network side apparatus determines that communication with the UE needs to be performed on a carrier in a shared spectrum by using a Cell-ID, or when receiving a Cell-ID and a time location t that are sent by the network side apparatus when a timing moment arrives, or when receiving a Cell-ID and a time location t that are sent by the network side apparatus according to a request of the UE, or when receiving a Cell-ID and a time location t that are sent by the network side apparatus when the network side apparatus determines to connect to the UE, determining to perform time alignment; and

the aligning an alignment system time with a time location in a time segment in stored M time segments specifically includes:

determining, according to the correspondences between the stored M time segments and the Cell-IDs, a time segment that corresponds to the received Cell-ID; and

aligning the alignment system time with a time location t in the determined time segment.

According to a fifth aspect, a network side apparatus is provided, including:

a first sending unit, configured to send, in a primary cell (Pcell), a first wireless network identifier to UE, where a carrier used in the Pcell is a carrier in a non-shared spectrum; and

a second sending unit, configured to send, in a secondary cell (Scell), a second wireless network identifier that is the same as the first wireless network identifier to the UE, so that the UE determines whether the UE can communicate with a network side apparatus in the Scell, where a carrier used in the Scell is a carrier in a shared spectrum, and the first wireless network identifier/the second wireless network identifier uniquely identifies a wireless network operator.

With reference to the fifth aspect, in a first possible implementation manner, the apparatus further includes: a scheduling stopping unit, configured to: after the first wireless network is sent, in the Pcell, to the UE and the second wireless network identifier is sent, in the Scell, to the UE, when determining that feedback information that is returned by the UE and that includes a signal measurement result for the Scell is not received, or when determining that feedback information that is returned by the UE and that indicates that a signal measurement result for the Scell is invalid is received, or when determining that feedback information that is returned by the UE and that instructs to change a cell identifier of the Scell is received, skip performing resource configuration and data scheduling for the UE or changing the cell identifier of the Scell; and

a scheduling unit, configured to: after the first wireless network identifier is sent, in the Pcell, to the UE and the second wireless network identifier is sent, in the Scell, to the UE, when the feedback information that is returned by the UE and that includes the signal measurement result for the Scell is received, perform resource configuration and data scheduling for the UE according to the signal measurement result for the Scell.

With reference to the fifth aspect, in a second possible implementation manner, the second sending unit is specifically configured to send, in the Scell, the second wireless network identifier to the UE by using a first downlink shared channel, where a transmission channel of scheduling information that corresponds to the first downlink shared channel is in first common search space of a control channel, and the first common search space of a control channel is common search space of the Pcell or common search space of the Scell; or

the second sending unit is specifically configured to send, in the Scell, the second wireless network identifier to the UE by using a second downlink shared channel, where a resource that corresponds to the second downlink shared channel is a preset resource that corresponds to a cell identifier of the Scell; or

the second sending unit is specifically configured to send, in the Scell to the UE by using a third downlink shared channel, the second wireless network identifier and a preset sequence that is used to identify the second wireless network identifier.

According to a sixth aspect, user equipment (UE) for determining to use a spectrum is provided, including:

a searching unit, configured to receive a first wireless network identifier that is sent in a primary cell (Pcell) by a network side apparatus, and search for a second wireless network identifier that is sent in a secondary cell (Scell) by the network side apparatus, where a carrier used in the Pcell is a carrier in a non-shared spectrum, and a carrier used in the Scell is a carrier in a shared spectrum;

a first determining unit, configured to: when the second wireless network identifier that is sent in the Scell by the network side apparatus is received, and determining that the second wireless network identifier is consistent with the first wireless network identifier that is sent in the Pcell by the network side apparatus, determine that communication with the network side apparatus can be performed in the Scell; and

a second determining unit, configured to: when the second wireless network identifier that is sent in the Scell by the network side apparatus is not received, or when the second wireless network identifier that is sent in the Scell by the network side apparatus is received, and determining that the second wireless network identifier is inconsistent with the first wireless network identifier that is sent in the Pcell by the network side apparatus, determine that communication with the network side apparatus cannot be performed in the Scell.

With reference to the sixth aspect, in a first possible implementation manner, the UE further includes:

a first feedback unit, configured to: feedback a signal measurement result for the Scell to the network side apparatus when determining that communication with the network side apparatus can be performed in the Scell; or

a second feedback unit, configured to: skip feeding back a signal measurement result for the Scell to the network side apparatus when determining that communication with the apparatus cannot be performed in the Scell, or feedback, to the network side apparatus, feedback information that indicates that a signal measurement result for the Scell is invalid when determining that communication with the apparatus cannot be performed in the Scell, or feedback, to the network side apparatus, feedback information that instructs to change a cell identifier of the Scell when determining that communication with the apparatus cannot be performed in the Scell.

With reference to the sixth aspect, in a second possible implementation manner, the searching unit is configured to search, by using a first downlink shared channel, for the second wireless network identifier that is sent in the Scell by the network side apparatus, where a transmission channel of scheduling information that corresponds to the first downlink shared channel is in first common search space of a control channel, and the first common search space of a control channel is common search space of the Pcell or common search space of the Scell; or

the searching unit is specifically configured to search, by using a second downlink shared channel, for the second wireless network identifier that is sent in the Scell by the network side apparatus, where a resource that corresponds to the second downlink shared channel is a preset resource that corresponds to a cell identifier of the Scell; or

the searching unit is specifically configured to search, on a third downlink shared channel according to a stored preset sequence, for the second wireless network identifier that is sent in the Scell by the network side apparatus.

According to a seventh aspect, a network side apparatus is provided, including:

a time alignment unit, configured to: when determining to perform time alignment, align an alignment system time with a time location in a time segment according to stored M time segments, and establish, according to a circular order of the stored M time segments, relationships in which the M time segments correspond to system time in the preset circular order, where M is an integer greater than 1; and

a communications unit, configured to: when determining that communication with user equipment (UE) needs to be performed on a carrier in a shared spectrum by using a Cell-ID, determine, according to the established relationships in which the M time segments correspond to the system time in the preset circular order, a time segment that corresponds to current system time, determine, according to correspondences between the stored M time segments and Cell-IDs, a Cell-ID that corresponds to the time segment, and perform communication with the UE on the carrier in the shared spectrum by using the determined Cell-ID, where for different wireless network operators, Cell-IDs that correspond to a same time segment are different.

With reference to the seventh aspect, in a first possible implementation manner, the apparatus further includes:

a delivering unit, configured to deliver the stored M time segments, the circular order of the M time segments, and the correspondences between the M time segments and the Cell-IDs to the UE.

With reference to the seventh aspect, in a second possible implementation manner, the apparatus further includes:

a first notification unit, configured to: when a timing moment arrives, determine a time segment of the current system time, and a time location t, of the current system time, in the time segment; and broadcast, to the UE, the determined time location t and a Cell-ID that corresponds to the time segment of the current system time; or

a second notification unit, configured to: when a time request of the UE is received, determine a time segment of the current system time, and a time location t, of the current system time, in the time segment; and send, to the UE, the determined time location t and a Cell-ID that corresponds to the time segment of the current system time; or

a third notification unit, configured to: when determining that a connection with the UE needs to be established, determine a time segment T of the current system time, and a time location t, of the current system time, in the time segment; and send, to the UE, the determined time location t and a Cell-ID that corresponds to the time segment of the current system time.

With reference to the seventh aspect, in a second possible implementation manner, the communications unit is further configured to: when performing communication with the UE on the carrier in the shared spectrum by using the Cell-ID that corresponds to the time segment,

send a time location t, of the current system time, in the time segment to the UE.

According to an eighth aspect, user equipment (UE) is provided, including:

a time alignment unit, configured to: when determining to perform time alignment, align an alignment system time with a time location in a time segment in stored M time segments, and establish, according to a circular order of the stored M time segments, relationships in which the M time segments correspond to system time in the preset circular order, where M is an integer greater than 1; and

a communications unit, configured to: when determining that communication with a network side apparatus needs to be performed on a carrier in a shared spectrum by using a Cell-ID, determine, according to the established relationships in which the M time segments correspond to the system time in the preset circular order, a time segment that corresponds to current system time, determine, according to correspondences between the stored M time segments and Cell-IDs, a Cell-ID that corresponds to the time segment, and perform communication with the network side apparatus on the carrier in the shared spectrum by using the determined Cell-ID.

With reference to the eighth aspect, in a first possible implementation manner, when receiving a Cell-ID and a time location t that are sent by the network side apparatus when the network side apparatus determines that communication with the UE needs to be performed on a carrier in a shared spectrum by using a Cell-ID, or when receiving a Cell-ID and a time location t that are sent by the network side apparatus when a timing moment arrives, or when receiving a Cell-ID and a time location t that are sent by the network side apparatus according to a request of the UE, or when receiving a Cell-ID and a time location t that are sent by the network side apparatus when the network side apparatus determines to connect to the UE, the time alignment unit determines to perform time alignment; and determines, according to the correspondences between the stored M time segments and the Cell-IDs, a time segment that corresponds to the received Cell-ID; and aligns the alignment system time with a time location t in the determined time segment.

By means of the methods for indicating and determining to use a spectrum, and the apparatus that are provided by the present application, specifically, the following beneficial effects are achieved: In the present application, a network side apparatus sends, in a Pcell and a Scell, a same wireless network identifier, so that UE can determine whether the UE can communicate, in the Scell, with the network side apparatus by using a carrier in a shared spectrum, and the UE can determine, according to a status of receiving two wireless network identifiers, whether different operators use a same Cell-ID in the shared spectrum and feed back a determining result to the network side apparatus. This avoids a problem of subsequent chaotic user data scheduling performed by a network that is caused by an invalid or erroneous scheduling result that is produced because different operators plan cells with a same Cell-ID in a shared spectrum in a same geographical area.

### BRIEF DESCRIPTION OF THE DRAWINGS

FIG. 1 is a schematic diagram showing that a Cell 2 planned by an operator 1 in an unlicensed spectrum and a Cell 2 planned by an operator 2 in the unlicensed spectrum are located in a same geographical area;

FIG. 2 is a flowchart of a method for indicating, by a network side apparatus, to use a spectrum according to an embodiment of the present application;

FIG. 3 is a flowchart of a method for determining, by user equipment, to use a spectrum according to an embodiment of the present application;

FIG. 4 is a schematic diagram showing that a network side apparatus sends same PLMN information in both a primary cell and a secondary cell according to an embodiment of the present application;

FIG. 5 is a schematic diagram showing that first common search space of a control channel is common search space of a Pcell according to an embodiment of the present application;

FIG. 6 is a schematic diagram of another cell with a same Cell-ID that is deployed by another operator in a neighboring geographical area;

FIG. 7 is a schematic diagram showing that first common search space of a control channel is common search space of a Scell according to an embodiment of the present application;

FIG. 8 is a schematic diagram showing that a resource that corresponds to a second downlink shared channel is a preset particular resource according to an embodiment of the present application;

FIG. 9 is a flowchart of a method for determining, by a network side apparatus, a cell identifier in a spectrum according to an embodiment of the present application;

FIG. 10 is a flowchart of a method for determining, by user equipment (UE), a cell identifier in a spectrum according to an embodiment of the present application;

FIG. 11 is a schematic diagram of a time-variant Cell-ID that a network side apparatus plans and uses in a shared spectrum according to an embodiment of the present application;

FIG. 12 is a structural diagram of a first network side apparatus according to an embodiment of the present application;

FIG. 13 is a structural diagram of first UE according to an embodiment of the present application;

FIG. 14 is a structural diagram of a second network side apparatus according to an embodiment of the present application; and

FIG. 15 is a structural diagram of second UE according to an embodiment of the present application.

### DETAILED DESCRIPTION

Methods for indicating and determining to use a spectrum, and an apparatus that are provided by the present application are described in further detail below with reference to accompanying drawings and embodiments.

The present application resolves a problem of planning a Cell-ID when different operators use a shared spectrum to deploy networks of an LTE system, and resolves a problem of chaotic user data scheduling performed by a network that may be caused by an invalid or erroneous scheduling result that is produced because different operators plan cells with a same Cell-ID in a shared spectrum in a same geographical area because an operator does not consider a network planning status of another operator when using the shared spectrum.

For a network side apparatus, Embodiment 1 of the present application provides a method for indicating to use a spectrum, and as shown in FIG. 2, the method includes:

Step 201. Send, in a primary cell (Pcell), a first wireless network identifier to UE, where a carrier used in the Pcell is a carrier in a non-shared spectrum.

Step 202. Send, in a secondary cell (Scell), a second wireless network identifier that is the same as the first wireless network identifier to the UE, so that the UE determines, according to a status of receiving the two wireless network identifiers, whether the UE can communicate with a network side apparatus in the Scell, where a carrier used in the Scell is a carrier in a shared spectrum, and the first wireless network identifier/the second wireless network identifier can uniquely identify one wireless network operator within a range of a same geographical area.

The carrier in the non-shared spectrum is used in the Pcell; therefore, the UE can receive the first wireless network identifier that is sent in the Pcell by the network side apparatus. As the carrier in the shared spectrum is used in the Scell, and when different operators plan a same Cell-ID in the shared spectrum in the same geographical area, the UE may not receive or may receive a wireless network identifier that is different from that in the Pcell, the UE needs to search for the second wireless network identifier that is sent in the Scell by the network side apparatus, and may determine, according to a status of receiving the second wireless network identifier in the shared spectrum, whether a network side apparatus can communicate with the UE on a resource in the shared spectrum.

A sequence of performing step 201 and step 202 is not limited in this embodiment of the present application, that is, the two wireless network identifiers may be sent simultaneously, or may be sent separately.

The network side apparatus is a base station, and the base station may be, for example, a base transceiver station (BTS), a node B, an evolved node B (eNode B or eNB), a home Node B (HNB), an evolved home Node B (Home eNode B or HeNB), a macro base station, or another similar apparatus.

The first/second wireless network identifier used to uniquely identify a wireless network operator may be, but is not limited to, partial or all content (referred to as PLMN information in this embodiment) of a public land mobile network identifier PLMN ID.

PLMN=MCC+MNC, where the MCC (mobile country code) is a three-digit number, and the MNC (Mobile Network Code) is a mobile network code allocated by the government, and is two-digit number or a three-digit number.

PLMN information is a part, which can distinguish different operators in a same geographical area, in a PLMN. For example, because MCC information in a PLMN in a same geographical area is the same, PLMN information to be sent may be MNC information in the PLMN.

Optionally, the network side apparatus is configured to send, in the Pcell, the first wireless network identifier to the UE, and send, in the Scell, the second wireless network identifier to the UE by broadcasting system information block (SIB-1).

Optionally, after sending, in the Pcell, the first wireless network identifier to the UE, and sending, in the Scell, the second wireless network identifier to the UE, the network side apparatus further performs any one of the following steps:

(1) when determining that feedback information that is returned by the UE and that includes a signal measurement result for the Scell is not received, or when determining that feedback information that is returned by the UE and that indicates that a signal measurement result for the Scell is invalid is received, or when determining that feedback information that is returned by the UE and that instructs to change a cell identifier of the Scell is received, skipping performing resource configuration, data scheduling, and the like for the UE;

(2) when determining that the feedback information that is returned by the UE and that includes the signal measurement result for the Scell is not received, or when determining that the feedback information that is returned by the UE and that indicates that the signal measurement result for the Scell is invalid is received, or when determining that the feedback information that is returned by the UE and that instructs to change the cell identifier of the Scell is received, changing the cell identifier of the Scell; and

(3) when the feedback information that is returned by the UE and that includes the signal measurement result for the Scell is received, performing resource configuration and data scheduling for the UE according to the signal measurement result for the Scell.

According to an information feedback of the UE, the network side apparatus replaces a Cell-ID of a carrier in a shared spectrum or does not perform resource configuration, data scheduling, or the like for the UE. This avoids a problem of chaotic user data scheduling performed by a network that is caused by an invalid or erroneous scheduling result that is produced because different operators plan cells with a same Cell-ID in a shared spectrum in a same geographical area.

A specific manner of sending, in the Scell, the wireless network identifier by the network side apparatus may be any one of the following manners:

Manner 1: The second wireless network identifier is sent, in the Scell, to the UE by using a first downlink shared channel, where a transmission channel of scheduling information that corresponds to the first downlink shared channel is in first common search space of a control channel, and the first common search space of a control channel is common search space of the Pcell or common search space of the Scell.

Manner 2: The second wireless network identifier is sent, in the Scell, to the UE by using a second downlink shared channel, where a resource that corresponds to the second downlink shared channel is a preset resource that corresponds to a cell identifier of the Scell.

Manner 3: The second wireless network identifier and a preset sequence that is used to identify the second wireless network identifier are sent, in the Scell, to the UE.

It may be set in such a manner that there is a preset location relationship between a location at which a preset sequence is sent and a location at which a wireless network identifier is sent, for example, the second wireless network identifier is transmitted before the preset sequence or after the preset sequence. In this way, when the UE detects, according to a stored preset sequence, that the preset sequence is received, the UE can identify the second network identifier by using the preset location relationship. Certainly, a preset operation may also be performed on the preset sequence and the second wireless network identifier, for example, an exclusive OR operation or the like is performed, and in this way, the UE side may perform an inverse operation on a received signal by using the first wireless network identifier of the Pcell, and determine whether a result of the inverse operation is related to the stored preset sequence, and may further determine whether the wireless network identifier sent in the Scell is correctly received.

Optionally, the second wireless network identifier and the preset sequence are transmitted on the third downlink shared channel in a manner of scrambling the preset sequence by using the second wireless network identifier.

The preset sequence is any one or more of the following sequences: a primary synchronization signal (PSS) sequence, a secondary synchronization signal (SSS) sequence, and a cell-specific reference signal (CRS) sequence.

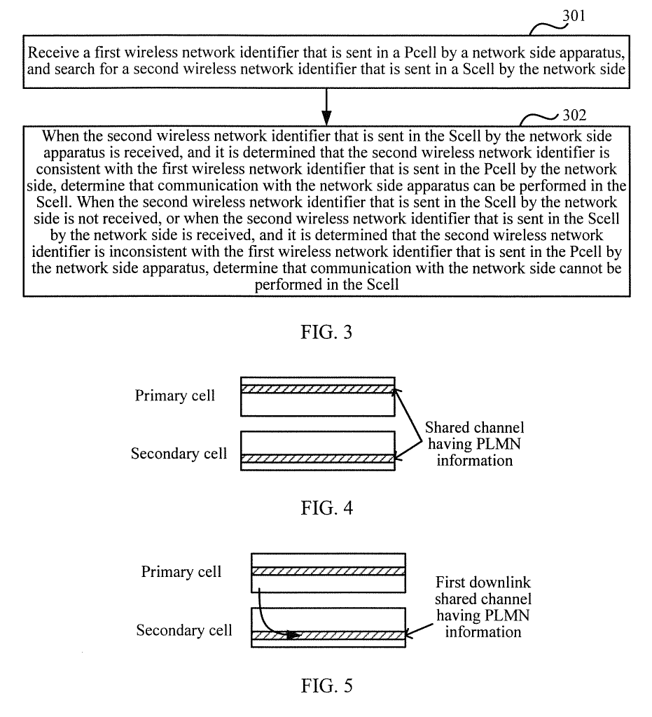

For user equipment (UE), Embodiment 2 of the present application further provides a method for determining to use a spectrum, and as shown in FIG. 3, the method includes:

Step 301. Receive a first wireless network identifier that is sent in a Pcell by a network side apparatus, and search for a second wireless network identifier that is sent in a Scell by the network side apparatus, where a carrier used in the Pcell is a carrier in a non-shared spectrum, and a carrier used in the Scell is a carrier in a shared spectrum.

Step 302. When the second wireless network identifier that is sent in the Scell by the network side apparatus is received, and it is determined that the second wireless network identifier is consistent with the first wireless network identifier that is sent in the Pcell by the network side apparatus, determine that communication with the network side apparatus can be performed in the Scell. When the second wireless network identifier that is sent in the Scell by the network side apparatus is not received, or when the second wireless network identifier that is sent in the Scell by the network side apparatus is received, and it is determined that the second wireless network identifier is inconsistent with the first wireless network identifier that is sent in the Pcell by the network side apparatus, determine that communication with the network side apparatus cannot be performed in the Scell.

The UE may identify, according to a status of receiving the two wireless network identifiers, whether different operators use a same Cell-ID in a shared spectrum. This avoids a problem of chaotic user data scheduling performed by a network that is caused by an invalid or erroneous scheduling result that is produced because different operators plan cells with a same Cell-ID in a shared spectrum in a same geographical area.

Optionally, each of the wireless network identifiers is partial or all content of a public land mobile network (PLMN) information. Further, optionally, each of the wireless network identifiers is a mobile network code (MNC) in a PLMN.

Optionally, by broadcasting system information block (SIB-1), the UE receives the first wireless network identifier that is sent in the Pcell by the network side apparatus, and searches for the second wireless network identifier that is sent in the Scell by the network side apparatus.

Optionally, according to a status of receiving the two wireless network identifiers, the following processing is performed:

(1) when determining that communication with the network side apparatus can be performed in the Scell, feeding back a signal measurement result for the Scell to the network side apparatus; or

(2) when determining that communication with the network side apparatus cannot be performed in the Scell, skipping feeding back a signal measurement result for the Scell to the network side apparatus, or feeding back, to the network side apparatus, feedback information that indicates that a signal measurement result for the Scell is invalid, or feeding back, to the network side apparatus, feedback information that instructs to change a cell identifier of the Scell.

If the UE identifies that communication with the UE cannot be performed by using a resource in the shared spectrum, that is, a network device of another operator may use a same Cell-ID to deploy a network on the resource of the shared spectrum currently, the UE does not feedback a measurement result of the UE in the shared spectrum to the network side apparatus, and the network side apparatus may not configure the resource in the shared spectrum for the UE when the network side apparatus does not receive the measurement result, which is fed back by the UE, in the shared spectrum. Alternatively, the UE feeds back, to the network side apparatus, indication information indicating that a measurement result in the shared spectrum is invalid or indication information indicating that a Cell-ID of the Scell needs to be replaced, and the network side apparatus may replace a Cell-ID of a carrier in the shared spectrum according to the indicating information. This avoids a problem of chaotic user data scheduling performed by a network that is caused by an invalid or erroneous scheduling result that is produced because different operators plan cells with a same Cell-ID in a shared spectrum in a same geographical area.

A specific manner of searching, by the UE, for the wireless network identifier sent in the Scell by the network side apparatus may be any one of the following manners:

Manner 1: The second wireless network identifier that is sent in the Scell by the network side apparatus is searched for by using a first downlink shared channel, where a transmission channel of scheduling information that corresponds to the first downlink shared channel is in first common search space of a control channel, and the first common search space of a control channel is common search space of the Pcell or common search space of the Scell.

Manner 2: The second wireless network identifier that is sent in the Scell by the network side apparatus is searched for by using a second downlink shared channel, where a resource that corresponds to the second downlink shared channel is a preset resource that corresponds to a cell identifier of the Scell.

Manner 3: The second wireless network identifier that is sent in the Scell by the network side apparatus is searched for on a third downlink shared channel according to a stored preset sequence.

Specifically, a received signal is descrambled by using the second wireless network identifier that is sent in the Pcell by the network side apparatus; and it is determined that the descrambled signal is related to the preset sequence stored by the UE side; and it is determined that the wireless network identifier that is sent in the Scell by the network side apparatus is received, and it is determined that the wireless network identifier is consistent with the wireless network identifier that is sent in the Pcell by the network side apparatus.

The preset sequence is any one or more of the following sequences: a primary synchronization signal (PSS) sequence, a secondary synchronization signal (SSS) sequence, and a cell-specific reference signal (CRS) sequence.

Embodiment 3 of the present application provides, in combination of a network side apparatus and a UE side, a method for indicating to use a spectrum and a method for determining, by UE, to use a spectrum.

A carrier in a non-shared spectrum is used in a Pcell, and a carrier in a shared spectrum is used in a Scell. As shown in FIG. 4, a network side apparatus sends, in the Pcell, a first wireless network identifier, and sends, in the Scell, a second wireless network identifier, where the first wireless network identifier and the second wireless network are a same PLMN. UE receives PLMN information sent in the Pcell by the network side apparatus, and searches for PLMN information sent in the Scell by the network side apparatus. When the PLMN information that is sent in the Scell by the network side apparatus is received, and it is determined that the PLMN information is consistent with the PLMN information that is sent in the Pcell by the network side apparatus, the UE determines that communication with the network side apparatus can be performed in the Scell. When the PLMN that is sent in the Scell by the network side apparatus is not received, or when the PLMN information that is sent in the Scell by the network side apparatus is received, and it is determined that the PLMN information is inconsistent with the PLMN information that is sent in the Pcell by the network side apparatus, the UE determines that communication with the network side apparatus cannot be performed in the Scell.

Optionally, when determining that communication with the network side apparatus can be performed in the Scell, the UE feeds back a signal measurement result for the Scell to the network side apparatus. When receiving feedback information that is returned by the UE and that includes the signal measurement result for the Scell, the network side apparatus performs resource configuration and data scheduling for the UE according to the signal measurement result for the Scell.

When determining that communication with the network side apparatus cannot be performed in the Scell, the UE does not feedback a signal measurement result for the Scell to the network side apparatus, or feeds back, to the network side apparatus, feedback information that indicates that the signal measurement result for the Scell is invalid, or feeds back, to the network side apparatus, feedback information that instructs to change a cell identifier of the Scell. When determining that the feedback information that is returned by the UE and that includes the signal measurement result for the Scell is not received, or when determining that the feedback information that is returned by the UE and that indicates that the signal measurement result for the Scell is invalid is received, or when determining that the feedback information that is returned by the UE and that instructs to change the cell identifier of the Scell is received, the network side apparatus does not perform resource configuration or data scheduling for the UE, or changes the cell identifier of the Scell.

A specific implementation manner of sending, in the Scell, the PLMN by the network side apparatus and searching, by the UE, for the PLMN in the Scell is as follows:

Manner 1

The network side apparatus sends, in the Scell, the PLMN to the UE by using a first downlink shared channel. The UE searches, by using the first downlink shared channel, for the PLMN that is sent in the Scell by the network side apparatus.

A transmission channel of scheduling information that corresponds to the first downlink shared channel is in first common search space of a control channel, and the first common search space of a control channel is common search space of the Pcell or common search space of the Scell.

If the first common search space of a control channel is the common search space of the Pcell, as shown in FIG. 5, the scheduling information of the first downlink shared channel in the Scell is sent to the UE by using a control channel in the Pcell, without a need to increase a quantity of times of blind detection performed by the UE in the Scell or to allocate common search space to the Scell.

If the first common search space of a control channel is the common search space of the Scell, as shown in FIG. 7, the scheduling information of the first downlink shared channel in the Scell is sent to the UE by using a control channel in the Scell.

The UE may not detect PLMN information when receiving and demodulating PLMN information in the Scell according to the scheduling information, received on the control channel in the Pcell/Scell, of the first downlink shared channel.

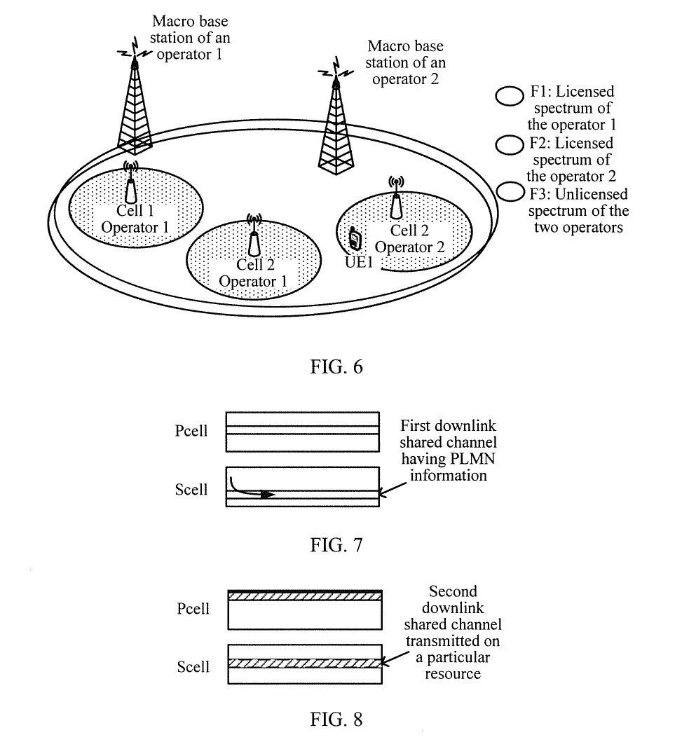

That the PLMN information is not detected may be caused by a scenario 1 shown in FIG. 6. That is, another operator deploys another cell with a same Cell-ID in a neighboring geographical area, UE 1 is originally UE of an operator 1, and the UE moves to a range of a Cell 2 of an operator 2. The UE detects a first downlink shared channel in Cell 2/Operator 1 by receiving the scheduling information, sent on the control channel in the Pcell/Scell by the network side apparatus, of the first downlink shared channel, but the UE is already far away from Cell 2/Operator 1 and is near Cell 2/Operator 2. In this case, the UE may not detect the first downlink shared channel in Cell 2/Operator 1, and as a result, cannot detect the PLMN information in the Scell.

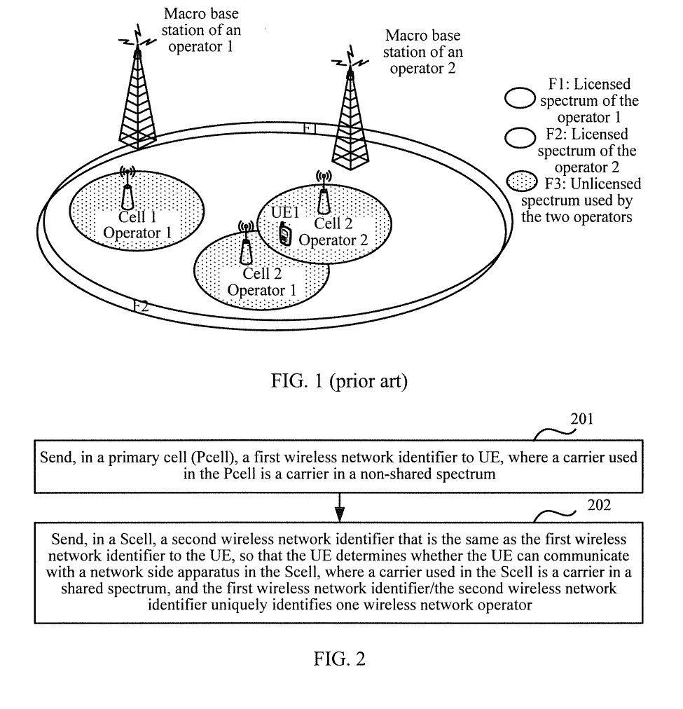

That the PLMN information is not detected may also be caused by a scenario 2 shown in FIG. 1. That is, another operator deploys another cell with a same Cell-ID in a same geographical area, and UE 1 is originally UE of an operator 1. The UE detects a first downlink shared channel in Cell 2/Operator 1 by receiving the scheduling information, sent on the control channel in the Pcell by the network side apparatus, of the first downlink shared channel. However, the first downlink shared channel in Cell 2/Operator 1 is interfered by Cell 2/Operator 2, and in this case, the UE may not detect the first downlink shared channel in Cell 2/Operator 1, and as a result, cannot detect the PLMN information in the Scell. Alternatively, the UE detects a first downlink shared channel in Cell 2/Operator 1 by receiving the scheduling information, sent on the control channel in the Scell by the network side apparatus, of the first downlink shared channel. However, the first downlink shared channel in Cell 2/Operator 1 and a transmission channel of scheduling information that corresponds to the first downlink shared channel are interfered by Cell 2/Operator 2, and in this case, the UE may not detect the scheduling information of the first downlink shared channel in Cell 2/Operator 1 and information on the first downlink shared channel, and as a result, cannot detect the PLMN information in the Scell.

Manner 2

The network side apparatus sends, in the Scell, the PLMN to the UE by using a second downlink shared channel, and the UE searches, by using the second downlink shared channel, for the PLMN that is sent in the Scell by the network side apparatus, where a resource that corresponds to the second downlink shared channel is a preset resource that corresponds to a cell identifier of the Scell, as shown in FIG. 8.

When receiving and demodulating the PLMN information in the Scell on the preset resource, the UE may detect that the PLMN information in the Scell is different from the PLMN information in the Pcell.

That the PLMN information in the Scell is different from the PLMN information in the Pcell may be caused by the scenario 1 shown in FIG. 6. Because the UE is closer to Cell 2/Operator 2, and preset particular resources for sending the second downlink shared channel are the same, the UE detects, on the particular resource, the second downlink shared channel in Cell 2/Operator 2, and therefore detects PLMN information sent by Cell 2/Operator 2 and the PLMN information received in the Pcell by the UE 1.

In addition, in this case, the UE may not detect the PLMN information in the Scell.

That the PLMN information is not detected may also be caused by the scenario 2 shown in FIG. 1. The second downlink shared channel in Cell 2/Operator 1 is interfered by Cell 2/Operator 2, and in this case, the UE may not detect the second downlink shared channel in Cell 2/Operator 1, and as a result, cannot detect the PLMN information in the Scell.

Manner 3

The network side apparatus sends, in the Scell, the PLMN to the UE by using a third downlink shared channel, and the UE searches, by using the third downlink shared channel, for the PLMN that is sent in the Scell by the network side apparatus, where an agreed preset sequence such as a PSS sequence, an SSS sequence, or a CRS sequence is transmitted on the third downlink shared channel.

Optionally, the network side apparatus transmits the PLMN information and the preset sequence on the third downlink shared channel in a manner of scrambling the preset sequence by using the PLMN information. The UE descrambles a received signal by using the PLMN that is sent in the Pcell by the network side apparatus; determines that the descrambled signal is related to the preset sequence stored by the UE; and determines that the PLMN that is sent in the Scell by the network side apparatus is received, and determines that the PLMN is consistent with the PLMN that is sent in the Pcell by the network side apparatus.

For example, information about a CRS sequence transmitted on the third downlink shared channel in the Scell is S₁, S₂, . . . , and S_{N}, where N is a length of the CRS sequence, and PLMN information transmitted on the third downlink shared channel in the Scell is S′₁, S′₂, . . . , and S′_{M}, where M is a sequence length of the PLMN information, and M≦N. In this case, a sequence actually transmitted on the third downlink shared channel in the Scell is X, where

Xₙ=Sₙ₁+S′ₙ₂, Xₙ₊₁=Sₙ₁₊₁+S′ₙ₂₊₁, . . . .

When receiving and demodulating the PLMN information in the Scell, the UE may descramble the received signal according to the PLMN information that is received in the Pcell; the UE then compares the signal obtained after descrambling with preset CRS sequence information transmitted on the third downlink shared channel. If the signal obtained after descrambling is related to the CRS sequence information stored by the UE, the UE determines that the PLMN information transmitted on the third downlink shared channel in the Scell by the network side apparatus is the same as the PLMN information that is transmitted in the Pcell by the network side apparatus. Otherwise, if the signal obtained after descrambling is not related to the CRS sequence information stored by the UE, the UE determines that the PLMN information transmitted on the third downlink shared channel in the Scell by the network side apparatus is different from the PLMN information that is transmitted in the Pcell by the network side apparatus.

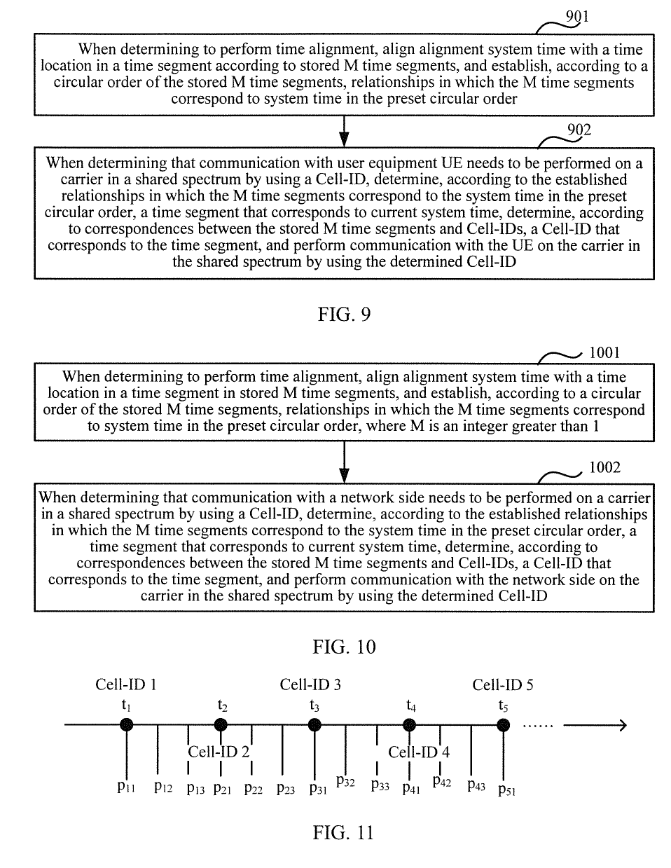

According to Embodiment 4 of the present application, for a network side apparatus, a method for determining a cell identifier in a spectrum is provided, and as shown in FIG. 9, the method includes:

Step 901. When determining to perform time alignment, align alignment system time with a time location in a time segment according to stored M time segments, and establish, according to a circular order of the stored M time segments, relationships in which the M time segments correspond to system time in the preset circular order, where M is an integer greater than 1.

Step 902. When determining that communication with user equipment (UE) needs to be performed on a carrier in a shared spectrum by using a Cell-ID, determine, according to the established relationships in which the M time segments correspond to the system time in the preset circular order, a time segment that corresponds to current system time, determine, according to correspondences between the stored M time segments and Cell-IDs, a Cell-ID that corresponds to the time segment, and perform communication with the UE on the carrier in the shared spectrum by using the determined Cell-ID, where for different wireless network operators, Cell-IDs that correspond to a same time segment are different.

In this embodiment of the present application, multiple time segments are predefined and stored, and after a moment of system time is aligned with a time point in a time segment, as the system time is updated, the M time segments correspond to system time in a preset circular order.

Optionally, the network side apparatus delivers the stored M time segments, the circular order of the M time segments, and the correspondences between the M time segments and the Cell-IDs to the UE, so that information maintained by the network side apparatus and the UE maintains consistent.

The network side apparatus and the UE side may agree on a manner of aligning system time with a time segment, or the network side apparatus and the UE side may agree on only the M time and the circular order of the M time segments, after the network side apparatus determines the manner of aligning with system time and a time segment, the network side apparatus may notify, in any one of the following manners, the UE of how to implement alignment, so that the UE determines a time segment that corresponds to current system time, and a location, of the current system time, in the time segment, to pre-learn a time at which switching to a next time segment is performed, and a Cell-ID that corresponds to each time segment, and to know that the network side apparatus uses which Cell-ID at which time.

Manner 1

When a timing moment arrives, the network side apparatus determines a time segment of the current system time, and a time location, of the current system time, in the time segment; and broadcasts, to the UE, the determined time location and a Cell-ID that corresponds to the time segment of the current system time.

Manner 2

When a time request of the UE is received, a time segment of the current system time, and a time location, of the current system time, in the time segment are determined; and the determined time location and a Cell-ID that corresponds to the time segment of the current system time are sent to the UE.

Manner 3

When the UE performs initial access or cell handover occurs, and it is determined that a connection with the UE needs to be established, a time segment of the current system time, and a time location, of the current system time, in the time segment are determined; and the determined time location and a Cell-ID that corresponds to the time segment of the current system time are sent to the UE.

Manner 4

When communication with the UE is performed on the carrier in the shared spectrum by using the Cell-ID that corresponds to the determined time segment, the method further includes: sending a time location, of the current system time, in the time segment to the UE.

That is, as long as the network side apparatus notifies the UE of both the time location, of the current system time, in the time segment, and the Cell-ID that corresponds to the time segment of the current system time, the UE side can implement time alignment.

Optionally, for different wireless network operators, Cell-IDs that correspond to a same time segment are different. This avoids a problem of chaotic user data scheduling performed by a network that is caused by an invalid or erroneous scheduling result that is produced because different operators plan cells with a same Cell-ID in a shared spectrum in a same geographical area.

For a UE side, Embodiment 5 of the present application further provides a method for determining a cell identifier in a spectrum, and as shown in FIG. 10, the method includes:

Step 1001. When determining to perform time alignment, align alignment system time with a time location in a time segment in stored M time segments, and establish, according to a circular order of the stored M time segments, relationships in which the M time segments correspond to system time in the preset circular order, where M is an integer greater than 1.

Step 1002. When determining that communication with a network side apparatus needs to be performed on a carrier in a shared spectrum by using a Cell-ID, determine, according to the established relationships in which the M time segments correspond to the system time in the preset circular order, a time segment that corresponds to current system time, determine, according to correspondences between the stored M time segments and Cell-IDs, a Cell-ID that corresponds to the time segment, and perform communication with the network side apparatus on the carrier in the shared spectrum by using the determined Cell-ID.

In this embodiment of the present application, a network side apparatus plans and uses, in a shared spectrum, a time-variant Cell-ID on a carrier in the shared spectrum, and user equipment determines, according to a Cell-ID time-variance rule, a Cell-ID currently used by the network side apparatus. According to the method in this embodiment of the present application, because a time-variant Cell-ID is used, Cell-IDs used by network devices of multiple operators on a resource in a shared spectrum are different as much as possible. This avoids a problem of chaotic user data scheduling performed by a network that is caused by an invalid or erroneous scheduling result that is produced because different operators plan cells with a same Cell-ID in a shared spectrum in a same geographical area.

Optionally, the UE may align system time with a corresponding time segment in a manner agreed on with the network side apparatus, or the UE may implement time alignment according to a notification of the network side apparatus, and any one of the following manners may be specifically used:

Manner 1

determining to perform time alignment when receiving a Cell-ID and a time location t that are sent by the network side apparatus when the network side apparatus determines that communication with the UE needs to be performed on a carrier in a shared spectrum by using a Cell-ID; determining, according to the correspondences between the stored M time segments and the Cell-IDs, a time segment that corresponds to the received Cell-ID; and aligning the alignment system time with a time location t in the determined time segment.

Manner 2

When a Cell-ID and a time location t that are sent by the network side apparatus when a timing moment arrives are received, it is determined to perform time alignment; a time segment that corresponds to the received Cell-ID is determined according to the correspondences between the stored M time segments and the Cell-IDs; and the alignment system time is aligned with a time location t in the determined time segment.

Manner 3

When a Cell-ID and a time location t that are sent by the network side apparatus when the network side apparatus determines to connect to the UE, it is determined to perform time alignment; a time segment that corresponds to the received Cell-ID is determined according to the correspondences between the stored M time segments and the Cell-IDs; and the alignment system time is aligned with a time location t in the determined time segment.

Manner 4

When a Cell-ID and a time location t that are sent by the network side apparatus according to a request of the UE are received, it is determined to perform time alignment; a time segment that corresponds to the received Cell-ID is determined according to the correspondences between the stored M time segments and the Cell-IDs; and the alignment system time is aligned with a time location t in the determined time segment.

In this embodiment of the present application, the network side apparatus plans and uses a time-variant Cell-ID in a shared spectrum, and as shown in FIG. 11, for example, a Cell-ID 1 is used in a period of t₁-t₂, a Cell-ID 2 is used in a period of t₂-t₃, . . . , and a Cell-ID 3 is used in a period of t₃-t₄, . . . . A time of tₙ-tₙ₊₁ may be divided into M equal time segments.

A rule of an order of the Cell-ID 1, the Cell-ID 2, the Cell-ID 3, . . . , and duration for which each Cell-ID is used may be agreed on by the network side apparatus and the user equipment. If the Cell-ID 1 is used currently, the network side apparatus and the user equipment agree, according to a preset rule, that the Cell-ID 2 is to be used at a next moment.

The rule of the order of the Cell-ID 1, the Cell-ID 2, the Cell-ID 3, . . . is related to PLMN information (which, similar to Embodiment 1, refers to a part or all of a PLMN) of an operator to which the network side apparatus belongs. For different wireless network operators, Cell-IDs that correspond to a same time segment are different. For example, the time of 24 hours of one day is equally divided to M time segments. Each operator can determine, according to PLMN information of the operator, a Cell-ID used in each time segment. For example, a predefined Cell-ID change mode is shown below. An operator whose PLMN information is 1 uses a predefined Cell-ID change mode in a first row in the predefined Cell-ID change mode, that is, the Cell-ID 1 is used in a first time segment of the M time segments, the Cell-ID 2 is used in a second time segment, . . . , and a Cell-ID M is used in an M^{th} time segment. An operator whose PLMN information is 2 uses a predefined Cell-ID change mode in a second row in the predefined Cell-ID change mode, that is, the Cell-ID 2 is used in the first time segment of the M time segments, the Cell-ID 3 is used in the second time segment, . . . , and the Cell-ID 1 is used in the M^{th} time segment, . . . . A Cell_ID_pattern is a predefined Cell_ID change rule in a shared spectrum, and a Cell_ID is deployed and planned in the shared spectrum according to the Cell_ID rule. The design principle of the Cell_ID_pattern is that a same Cell-ID is avoided as much as possible in a same time segment, and A specific Cell_ID_pattern is not limited in the present application, where

$$Cell\_ID \_pattern = [ \begin{matrix}Cell - ID 1 & Cell - ID 2 & … & Cell - IDM \\ Cell - ID 2 & Cell - ID 3 & … & Cell - ID 1 \\ … & … & … & … \\ Cell - IDM & Cell - ID 1 & … & Cell - IDM - 1\end{matrix} ] .$$

In the present application, a cell identifier planning rule is predefined or user equipment assists cell identifier planning, to avoid that different operators plan cells with a same Cell-ID in a shared spectrum in a same geographical area, or user equipment identifies that different operators use a same Cell-ID in a shared spectrum and feeds back an identification result to the network side apparatus. This avoids a problem of chaotic user data scheduling performed by a network that is caused by an invalid or erroneous scheduling result that is produced because different operators plan cells with a same Cell-ID in a shared spectrum in a same geographical area.

The present application is applicable to a shared spectrum in other licensed spectrums in addition to an unlicensed spectrum.

Based on the same inventive idea, embodiments of the present application further provide a network side apparatus and user equipment (UE). Because the principle of resolving a problem by the apparatus is similar to that of the method provided by the foregoing embodiments, for implementation of the apparatus, reference may be made to implementation of the method, and repeated details are not described again.

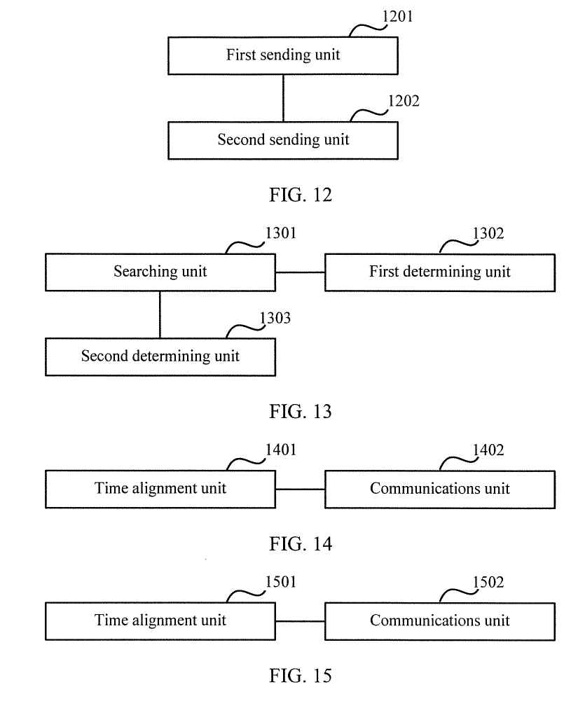

Embodiment 6 of the present application provides a network side apparatus, and as shown in FIG. 12, the apparatus includes:

a first sending unit 1201, configured to send, in a primary cell (Pcell), a first wireless network identifier to UE, where a carrier used in the Pcell is a carrier in a non-shared spectrum; and

a second sending unit 1202, configured to send, in a secondary cell (Scell), a second wireless network identifier that is the same as the first wireless network identifier to the UE, so that the UE determines whether the UE can communicate with a network side apparatus in the Scell, where a carrier used in the Scell is a carrier in a shared spectrum, and the first wireless network identifier/the second wireless network identifier uniquely identifies one wireless network operator.

Optionally, the apparatus further includes: a scheduling stopping unit, configured to: after the first wireless network is sent, in the Pcell, to the UE and the second wireless network identifier is sent, in the Scell, to the UE, when determining that feedback information that is returned by the UE and that includes a signal measurement result for the Scell is not received, or when determining that feedback information that is returned by the UE and that indicates that a signal measurement result for the Scell is invalid is received, or when determining that feedback information that is returned by the UE and that instructs to change a cell identifier of the Scell is received, skip performing resource configuration and data scheduling for the UE or changing the cell identifier of the Scell.

Optionally, the apparatus further includes: a scheduling unit, configured to: after the first wireless network identifier is sent, in the Pcell, to the UE and the second wireless network identifier is sent, in the Scell, to the UE, when the feedback information that is returned by the UE and that includes the signal measurement result for the Scell is received, perform resource configuration and data scheduling for the UE according to the signal measurement result for the Scell.

Optionally, the second sending unit specifically sends, in the Scell, the second wireless network identifier to the UE by using a first downlink shared channel, where a transmission channel of scheduling information that corresponds to the first downlink shared channel is in first common search space of a control channel, and the first common search space of a control channel is common search space of the Pcell or common search space of the Scell.

Optionally, the second sending unit is specifically configured to send, in the Scell, the second wireless network identifier to the UE by using a second downlink shared channel, where a resource that corresponds to the second downlink shared channel is a preset resource that corresponds to a cell identifier of the Scell.

Optionally, the second sending unit is specifically configured to send, in the Scell to the UE by using a third downlink shared channel, the second wireless network identifier and a preset sequence that is used to identify the second wireless network identifier.

Optionally, the second sending unit is specifically configured to send the second wireless network identifier and the preset sequence to the UE on the third downlink shared channel in a manner of scrambling the preset sequence by using the second wireless network identifier.

Optionally, the preset sequence used by the second sending unit is any one or more of the following sequences:

a primary synchronization signal (PSS) sequence, a secondary synchronization signal (SSS) sequence, and a cell-specific reference signal (CRS) sequence.

Optionally, the first wireless network identifier/the second wireless network identifier is partial or all content of a public land mobile network identifier (PLMN ID).

Optionally, the first wireless network identifier/the second wireless network identifier is a mobile network code (MNC) in a PLMN ID.

By broadcasting system information block (SIB-1), the first sending unit sends, in the Pcell, the first wireless network identifier to the UE, and the second sending unit sends, in the Scell, the second wireless network identifier to the UE.

Embodiment 7 of the present application provides a network side apparatus, including a processor and a data transceiver interface, where

the processor is configured to: send, in a primary cell (Pcell), a first wireless network identifier to UE, where a carrier used in the Pcell is a carrier in a non-shared spectrum; and send, in a secondary cell (Scell), a second wireless network identifier that is the same as the first wireless network identifier to the UE, so that the UE determines whether the UE can communicate with a network side apparatus in the Scell, where a carrier used in the Scell is a carrier in a shared spectrum, and the first wireless network identifier/the second wireless network identifier uniquely identifies one wireless network operator; and

the data transceiver interface is configured to implement data communication between the processor and the UE.

Correspondingly, Embodiment 8 of the present application further provides user equipment (UE) for determining to use a spectrum, and as shown in FIG. 13, the UE includes:

a searching unit 1301, configured to receive a first wireless network identifier that is sent in a primary cell (Pcell) by a network side apparatus, and search for a second wireless network identifier that is sent in a secondary cell (Scell) by the network side apparatus, where a carrier used in the Pcell is a carrier in a non-shared spectrum, and a carrier used in the Scell is a carrier in a shared spectrum;

a first determining unit 1302, configured to: when the second wireless network identifier that is sent in the Scell by the network side apparatus is received, and it is determined that the second wireless network identifier is consistent with the first wireless network identifier that is sent in the Pcell by the network side apparatus, determine that communication with the network side apparatus can be performed in the Scell; and

a second determining unit 1303, configured to: when the second wireless network identifier that is sent in the Scell by the network side apparatus is not received, or when the second wireless network identifier that is sent in the Scell by the network side apparatus is received, and it is determined that the second wireless network identifier is inconsistent with the first wireless network identifier that is sent in the Pcell by the network side apparatus, determine that communication with the network side apparatus cannot be performed in the Scell.

Optionally, the UE further includes: a first feedback unit, configured to: feedback a signal measurement result for the Scell to the network side apparatus when determining that communication with the network side apparatus can be performed in the Scell.

Optionally, the UE further includes:

a second feedback unit, configured to: when determining that communication with the network side apparatus cannot be performed in the Scell, skip feeding back a signal measurement result for the Scell to the network side apparatus, or feedback, to the network side apparatus, feedback information that indicates that a signal measurement result for the Scell is invalid, or feedback, to the network side apparatus, feedback information that instructs to change a cell identifier of the Scell.

Optionally, the searching unit is configured to search, by using a first downlink shared channel, for the second wireless network identifier that is sent in the Scell by the network side apparatus, where a transmission channel of scheduling information that corresponds to the first downlink shared channel is in first common search space of a control channel, and the first common search space of a control channel is common search space of the Pcell or common search space of the Scell.

Optionally, the searching unit is specifically configured to search, by using a second downlink shared channel, for the second wireless network identifier that is sent in the Scell by the network side apparatus, where a resource that corresponds to the second downlink shared channel is a preset resource that corresponds to a cell identifier of the Scell.

Optionally, the searching unit is specifically configured to search, on a third downlink shared channel according to a stored preset sequence, for the second wireless network identifier that is sent in the Scell by the network side apparatus.

Optionally, the searching unit is specifically configured to descramble a received signal by using the first wireless network identifier that is sent in the Pcell by the network side apparatus; and

the first determining unit is specifically configured to determine that the descrambled signal is related to the stored preset sequence; and determine that the second wireless network identifier that is sent in the Scell by the network side apparatus is received, and determine that the second wireless network identifier is consistent with the first wireless network identifier that is sent in the Pcell by the network side apparatus.

Optionally, the preset sequence is any one or more of the following sequences:

a primary synchronization signal (PSS) sequence, a secondary synchronization signal (SSS) sequence, and a cell-specific reference signal (CRS) sequence.

Optionally, the first wireless network identifier/the second wireless network identifier is partial or all content of a public land mobile network (PLMN).

Optionally, the first wireless network identifier/the second wireless network identifier is a mobile network code (MNC) in a PLMN.

The searching unit is specifically configured to: by broadcasting system information block (SIB-1), receive the first wireless network identifier that is sent in the Pcell by the network side apparatus, and search for the second wireless network identifier that is sent in the Scell by the network side apparatus.

Embodiment 9 of the present application provides UE, including a processor and a data transceiver interface, where

the processor is configured to: receive a first wireless network identifier that is sent in a primary cell (Pcell) by a network side apparatus, and search for a second wireless network identifier that is sent in a secondary cell (Scell) by the network side apparatus, where a carrier used in the Pcell is a carrier in a non-shared spectrum, and a carrier used in the Scell is a carrier in a shared spectrum; when the second wireless network identifier that is sent in the Scell by the network side apparatus is received, and it is determined that the second wireless network identifier is consistent with the first wireless network identifier that is sent in the Pcell by the network side apparatus, determine that communication with the network side apparatus can be performed in the Scell; and when the second wireless network identifier that is sent in the Scell by the network side apparatus is not received, or when the second wireless network identifier that is sent in the Scell by the network side apparatus is received, and it is determined that the second wireless network identifier is inconsistent with the first wireless network identifier that is sent in the Pcell by the network side apparatus, determine that communication with the network side apparatus cannot be performed in the Scell; and

the data transceiver interface is configured to implement data communication between the processor and the network side apparatus.

According to Embodiment 10 of the present application, a network side apparatus is further provided, and as shown in FIG. 14, the apparatus includes:

a time alignment unit 1402, configured to: when determining to perform time alignment, align alignment system time with a time location in a time segment according to stored M time segments, and establish, according to a circular order of the stored M time segments, relationships in which the M time segments correspond to system time in the preset circular order, where M is an integer greater than 1; and

a communications unit 1403, configured to: when determining that communication with user equipment (UE) needs to be performed on a carrier in a shared spectrum by using a Cell-ID, determine, according to the established relationships in which the M time segments correspond to the system time in the preset circular order, a time segment that corresponds to current system time, determine, according to correspondences between the stored M time segments and Cell-IDs, a Cell-ID that corresponds to the time segment, and perform communication with the UE on the carrier in the shared spectrum by using the determined Cell-ID, where for different wireless network operators, Cell-IDs that correspond to a same time segment are different.

Optionally, the apparatus further includes:

a delivering unit, configured to deliver the stored M time segments, the circular order of the M time segments, and the correspondences between the M time segments and the Cell-IDs to the UE.

Optionally, the apparatus further includes:

a timing determining unit, configured to: when a timing moment arrives, determine a time segment of the current system time, and a time location t, of the current system time, in the time segment; and

a broadcast unit, configured to broadcast, to the UE, the determined time location t and a Cell-ID that corresponds to the time segment of the current system time.

Optionally, the apparatus further includes:

a request determining unit, configured to: when a time request of the UE is received, determine a time segment of the current system time, and a time location t, of the current system time, in the time segment; and

a first sending unit, configured to send, to the UE, the determined time location t and a Cell-ID that corresponds to the time segment of the current system time.

Optionally, the apparatus further includes:

a connection determining unit, configured to: when determining that a connection with the UE needs to be established, determine a time segment T of the current system time, and a time location t, of the current system time, in the time segment; and

a second sending unit, configured to send, to the UE, the determined time location t and a Cell-ID that corresponds to the time segment of the current system time.

Optionally, the communications unit is further configured to: when performing communication with the UE on the carrier in the shared spectrum by using the Cell-ID that corresponds to the time segment,

send a time location t, of the current system time, in the time segment to the UE.

Optionally, for different wireless network operators, Cell-IDs that correspond to a same time segment are different.

Embodiment 11 of the present application further provides a network side apparatus, and the apparatus includes a processor and a data transceiver interface, where

the processor is configured to: when determining to perform time alignment, align alignment system time with a time location in a time segment according to stored M time segments, and establish, according to a circular order of the stored M time segments, relationships in which the M time segments correspond to system time in the preset circular order, where M is an integer greater than 1; and when determining that communication with user equipment (UE) needs to be performed on a carrier in a shared spectrum by using a Cell-ID, determine, according to the established relationships in which the M time segments correspond to the system time in the preset circular order, a time segment that corresponds to current system time, determine, according to correspondences between the stored M time segments and Cell-IDs, a Cell-ID that corresponds to the time segment, and perform communication with the UE on the carrier in the shared spectrum by using the determined Cell-ID, where for different wireless network operators, Cell-IDs that correspond to a same time segment are different; and

the data transceiver interface is configured to implement data communication between the processor and the UE.

Correspondingly, Embodiment 12 further provides user equipment (UE), and as shown in FIG. 15, the UE includes:

a time alignment unit 1501, configured to: when determining to perform time alignment, align alignment system time with a time location in a time segment in stored M time segments, and establish, according to a circular order of the stored M time segments, relationships in which the M time segments correspond to system time in the preset circular order, where M is an integer greater than 1; and

a communications unit 1502, configured to: when determining that communication with a network side apparatus needs to be performed on a carrier in a shared spectrum by using a Cell-ID, determine, according to the established relationships in which the M time segments correspond to the system time in the preset circular order, a time segment that corresponds to current system time, determine, according to correspondences between the stored M time segments and Cell-IDs, a Cell-ID that corresponds to the time segment, and perform communication with the network side apparatus on the carrier in the shared spectrum by using the determined Cell-ID.

Optionally, when receiving a Cell-ID and a time location t that are sent by the network side apparatus when the network side apparatus determines that communication with the UE needs to be performed on a carrier in a shared spectrum by using a Cell-ID, or when receiving a Cell-ID and a time location t that are sent by the network side apparatus when a timing moment arrives, or when receiving a Cell-ID and a time location t that are sent by the network side apparatus according to a request of the UE, or when receiving a Cell-ID and a time location t that are sent by the network side apparatus when the network side apparatus determines to connect to the UE, the time alignment unit determines to perform time alignment; and determines, according to the correspondences between the stored M time segments and the Cell-IDs, a time segment that corresponds to the received Cell-ID; and aligns the alignment system time with a time location t in the determined time segment.

Embodiment 13 of the present application further provides UE, and the UE includes a processor and a data transceiver interface, where

the processor is configured to: when determining to perform time alignment, align alignment system time with a time location in a time segment in stored M time segments, and establish, according to a circular order of the stored M time segments, relationships in which the M time segments correspond to system time in the preset circular order, where M is an integer greater than 1; and when determining that communication with a network side apparatus needs to be performed on a carrier in a shared spectrum by using a Cell-ID, determine, according to the established relationships in which the M time segments correspond to the system time in the preset circular order, a time segment that corresponds to current system time, determine, according to correspondences between the stored M time segments and Cell-IDs, a Cell-ID that corresponds to the time segment, and perform communication with the network side apparatus on the carrier in the shared spectrum by using the determined Cell-ID; and

the data transceiver interface is configured to implement data communication between the processor and the network side apparatus.

Persons skilled in the art should understand that the embodiments of the present application may be provided as a method, a system, or a computer program product. Therefore, the present application may use a form of hardware only embodiments, software only embodiments, or embodiments with a combination of software and hardware. Moreover, the present application may use a form of a computer program product that is implemented on one or more computer-usable storage media (including but not limited to a disk memory, a CD-ROM, an optical memory, and the like) that include computer-usable program code.

The present application is described with reference to the flowcharts and/or block diagrams of the method, the device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present application have been described, persons skilled in the art can make changes and modifications to these embodiments once they learn the basic inventive concept. Therefore, the following claims are intended to be construed as to cover the exemplary embodiments and all changes and modifications falling within the scope of the present application.

Obviously, persons skilled in the art can make various modifications and variations to the embodiments of the present application without departing from the spirit and scope of the embodiments of the present application. The present application is intended to cover these modifications and variations provided that they fall within the scope of protection defined by the following claims and their equivalent technologies.

What is claimed is:

1. A method for indicating, by a network side apparatus, to use a spectrum, the method comprising:
sending, in a primary cell (Pcell), a first wireless network identifier to user equipment (UE), wherein a carrier used in the Pcell is a carrier in a non-shared spectrum; and
sending, in a secondary cell (Scell), a second wireless network identifier that is the same as the first wireless network identifier to the UE, so that the UE determines whether the UE communicate with a network side apparatus in the Scell, wherein a carrier used in the Scell is a carrier in a shared spectrum, and the first wireless network identifier/the second wireless network identifier uniquely identifies one wireless network operator.

2. The method according to claim 1, wherein after sending, in the Pcell, the first wireless network identifier to UE and sending, in the Scell, the second wireless network identifier to the UE, the method further comprises:
when determining that feedback information that is returned by the UE and that comprises a signal measurement result for the Scell is not received, skipping performing resource configuration and data scheduling for the UE or changing the cell identifier of the Scell; and
when the feedback information that is returned by the UE and that comprises the signal measurement result for the Scell is received, performing resource configuration and data scheduling for the UE according to the signal measurement result for the Scell.

3. The method according to claim 1, wherein sending, in the Scell, the second wireless network identifier to the UE comprises:
sending, in the Scell, the second wireless network identifier to the UE by using a first downlink shared channel, wherein a transmission channel of scheduling information that corresponds to the first downlink shared channel is in first common search space of a control channel, and the first common search space of a control channel is common search space of the Pcell or common search space of the Scell.

4. The method according to claim 3, wherein sending, in the Scell to the UE by using the third downlink shared channel, the second wireless network identifier and the preset sequence that is used to identify the second wireless network identifier comprises:
sending the second wireless network identifier and the preset sequence to the UE on the third downlink shared channel in a manner of scrambling the preset sequence by using the second wireless network identifier, wherein the preset sequence is any one or more of the following sequences: a primary synchronization signal (PSS) sequence, a secondary synchronization signal (SSS) sequence, and a cell-specific reference signal (CRS) sequence.

5. The method according to claim 1, wherein the first wireless network identifier/the second wireless network identifier comprises:
a mobile country code (MCC) and a mobile network code (MNC) in a public land mobile network identifier (PLMN ID); or
an MNC in a PLMN ID.

6. The method according to claim 1, wherein:
sending, in the Pcell, the first wireless network identifier to UE comprises:
sending, in the Pcell, the first wireless network identifier to the UE by using a broadcasting system information block (SIB-1); and
sending, in the Scell, the second wireless network identifier to the UE comprises:
sending, in the Scell, the second wireless network identifier to the UE by using the SIB-1.

7. A method for determining, by user equipment (UE), to use a spectrum, the method comprising:
receiving a first wireless network identifier that is sent in a primary cell (Pcell) by a network side apparatus, and searching for a second wireless network identifier that is sent in a secondary cell (Scell) by the network side apparatus, wherein a carrier used in the Pcell is a carrier in a non-shared spectrum, and a carrier used in the Scell is a carrier in a shared spectrum;
when the second wireless network identifier that is sent in the Scell by the network side apparatus is received, determining that the second wireless network identifier is consistent with the first wireless network identifier that is sent in the Pcell by the network side apparatus and determining that communication with the network side apparatus is performed in the Scell; and
when the second wireless network identifier that is sent in the Scell by the network side apparatus is not received, determining that communication with the network side apparatus is not performed in the Scell.

8. The method according to claim 7, wherein when determining that communication with the network side apparatus is performed in the Scell, the method further comprises:
feeding back a signal measurement result for the Scell to the network side apparatus.

9. The method according to claim 7, wherein searching for the second wireless network identifier that is sent in the secondary cell (Scell) by the network side apparatus comprises:
searching, by using a first downlink shared channel, for the second wireless network identifier that is sent in the Scell by the network side apparatus, wherein a transmission channel of scheduling information that corresponds to the first downlink shared channel is in first common search space of a control channel, and the first common search space of a control channel is common search space of the Pcell or common search space of the Scell; or
searching, by using a second downlink shared channel, for the second wireless network identifier that is sent in the Scell by the network side apparatus, wherein a resource that corresponds to the second downlink shared channel is a preset resource that corresponds to a cell identifier of the Scell; or
searching, on a third downlink shared channel according to a stored preset sequence, for the second wireless network identifier that is sent in the Scell by the network side apparatus.

10. The method according to claim 9, wherein searching, on the third downlink shared channel according to the stored preset sequence, for the second wireless network identifier that is sent in the Scell by the network side apparatus comprises:
descrambling a received signal by using the first wireless network identifier that is sent in the Pcell by the network side apparatus; and
determining that the descrambled signal is related to the stored preset sequence;
determining that the second wireless network identifier that is sent in the Scell by the network side apparatus is received; and
determining that the second wireless network identifier is consistent with the first wireless network identifier that is sent in the Pcell by the network side apparatus, wherein the preset sequence is any one or more of the following sequences: a primary synchronization signal (PSS) sequence, a secondary synchronization signal (SSS) sequence, and a cell-specific reference signal (CRS) sequence.

11. The method according to claim 7, wherein the first wireless network identifier/the second wireless network identifier comprises:
a mobile country code (MCC) and a mobile network code (MNC) in a public land mobile network identifier (PLMN ID); or
an MNC in a PLMN ID.

12. The method according to claim 7, wherein:
receiving the first wireless network identifier that is sent in the Pcell by the network side comprises:
receiving, by using a broadcasting system information block (SIB-1), the first wireless network identifier that is sent in the Pcell by the network side apparatus; and
searching for a second wireless network identifier that is sent in a Scell by the network side apparatus comprises:
searching, by using the SIB-1, for the second wireless network identifier that is sent in the Scell by the network side apparatus.

13. A network side apparatus, comprising:
a processor; and
a non-transitory computer-readable storage medium coupled to the processor and storing programming instructions for execution by the processor, the programming instructions which, when executed by the processor, instruct the processor to:
send, in a primary cell (Pcell), a first wireless network identifier to user equipment (UE), wherein a carrier used in the Pcell is a carrier in a non-shared spectrum, and
send, in a secondary cell (Scell), a second wireless network identifier that is the same as the first wireless network identifier to the UE, so that the UE determines whether the UE communicate with a network side apparatus in the Scell, wherein a carrier used in the Scell is a carrier in a shared spectrum, and the first wireless network identifier/the second wireless network identifier uniquely identifies one wireless network operator.

14. The apparatus according to claim 13, wherein the programming instructions which, when executed by the processor, further instruct the processor to:
after the first wireless network is sent, in the Pcell, to the UE and the second wireless network identifier is sent, in the Scell, to the UE, determine that feedback information that is returned by the UE and that comprises a signal measurement result for the Scell is not received, and skip performing resource configuration and data scheduling for the UE or changing the cell identifier of the Scell; and
after the first wireless network identifier is sent, in the Pcell, to the UE and the second wireless network identifier is sent, in the Scell, to the UE, when the feedback information that is returned by the UE and that comprises the signal measurement result for the Scell is received, perform resource configuration and data scheduling for the UE according to the signal measurement result for the Scell.

15. The apparatus according to claim 13, wherein the programming instructions which, when executed by the processor, further instruct the processor to:
send, in the Scell, the second wireless network identifier to the UE by using a first downlink shared channel, wherein a transmission channel of scheduling information that corresponds to the first downlink shared channel is in first common search space of a control channel, and the first common search space of a control channel is common search space of the Pcell or common search space of the Scell.

16. The apparatus according to claim 15, wherein the programming instructions which, when executed by the processor, further instruct the processor to:
send the second wireless network identifier and the preset sequence to the UE on the third downlink shared channel in a manner of scrambling the preset sequence by using the second wireless network identifier, wherein the preset sequence is any one or more of the following sequences: a primary synchronization signal (PSS) sequence, a secondary synchronization signal (SSS) sequence, and a cell-specific reference signal (CRS) sequence.

17. The apparatus according to claim 15, wherein the programming instructions which when executed by the processor, instruct the processor to:
send, in the Pcell, the first wireless network identifier to the UE by using a broadcasting system information block (SIB-1); and
send, in the Scell, the second wireless network identifier to the UE by using the SIB-1.
